(19) United States
(12) Patent Application Publication
(10) Pub. No.: US 2005/0008996 A1
(43) Pub. Date: Jan. 13, 2005

(54) Method for holistic diagnosis and cards for its implementation

(76) Inventor: Anat Avivi-Meirson, Haifa (IL)

Correspondence Address: BRUCE E. LILLING;LILLING & LILLING P.C., P.O. BOX 560, GOLDEN BRIDGE, NY, 10526, US

(21) Appl. No.: 10/497,424

(22) PCT Filed:
(86) PCT No.: PCT/IL02/00958

(30) Foreign Application Priority Data
Nov. 30, 2001 (US) 60334084

(51) Int. Cl. G09B 19/00

(52) U.S. Cl. 434/236

(57) ABSTRACT

An apparatus and method for individual psychological diagnosis and treatment are disclosed, the diagnosis being Based on the theory of vibrations or frequencies of colors and the treatment being based on the theory of Bach Flower essences. The apparatus includes a plurality of cards (10) each having a first (100) and second (200) side. The first sides (100) of the cards (10) include three spaced apart, equal sized spheres colored with preferably one or two colors. The second sides (200) of the cards (10) include at least an image of a flowering plant (204). The method of the invention involves presenting the first sides (100) of the cards (10) to a person being assessed, reviewing the cards selected by the person based on the person's review of the colored spheres, and then providing a treatment regime based on the flower (204) depicted on the second sides of the selected cards.

### BACKGROUND OF THE INVENTION

1. Field of Invention

The invention relates to the field of holistic psychotherapy. Specifically, the invention involves an improved method used by healthcare providers and other practitioners for diagnosing psychological conditions of a person through the use of visual cue cards and then providing subsequent treatment for certain psychological problems or a means for self-healing.

2. Description of the Prior Art

The present invention was developed primarily in response to the need for a holistic psychotherapy method based on frequencies of light (i.e., color) in combination with Bach Flower remedies for complete diagnosis and treatment. According to the present holistic method, it is recognized that the vibrations or frequencies of colors may be identified with certain patterns of thinking. Treatment regimes can be based on the theories of vibrational healing. The theory of the present invention is based on the notion that each body organ has a specific frequency at which it vibrates and with the combined vibrations of all of the body's organs, physical and emotional harmony may be created. When a particular organ is out of vibrational balance, disharmony may result that after time can theoretically cause illness.

The theory of color has its roots in many ancient cultures and modem authorities have written about it. For example, the early Egyptians, the Tibetans (in the Book of the Dead), the Mayans (as part of their legal system), Edgar Cayce and others have written on the subject. In modern practice, as noted below, various techniques using visual cue cards have been developed that rely on color as part of a holistic method for assessment and subsequent treatment of persons by medical and non-medical practitioners.

There are different popular decks of cards that rely on color and patterns for holistic assessment. With most of them, the choice is unwieldy in that only one side of the card provides information and the other side, which is visible to the person being assessed, is identifiable with the rest of the cards. For example, in FIG. 1, one side of a card contains a colorful spiral (here shown in black and white) and within it a written interpretation. The other side of the card contains a constant element that does not allow for impressionistic choice by the person. That is, the side visible to the person being assessed has a uniform pattern or image (in this case, a solid color is presented). Using this technique, a person randomly chooses an unidentified card, which leaves no opportunity for analysis of the person's cognitive or intuitive selection process and is, therefore, somewhat a matter of luck in properly assessing the person's condition.

In another type of popular card, the option of focusing on one color for meditation purposes is provided, with the goal of achieving “quietness” of thought by looking at the color (as noted previously, it is recognized that the vibrations or frequencies of colors are identified with certain patterns of thinking). In cards of this type, the full series within the cards is aimed towards the same “calming” color. For instance, Bach Flower cards, as shown in FIG. 2, are comprised of 77 cards and divided into seven categories. On one side of those cards is a recommended color for meditation and on the other side is a picture of a plant. Each category has at least six to nine cards that have the same color on the first side, and the person being analyzed intuitively chooses a card. However, because of the number of cards with the same color, the person may be steered or “aimed” toward a particular card. The disadvantage of that method is that the choice is limited to only seven colors, when in practice there are recognized as many as 38 patterns of thinking. Thus, the selection of a card from this deck does not provide for complete holistic assessment.

As noted above, Bach Flower cards contain a picture of a plant on one side and a color on the other side. There are also other cards within the framework of the Bach Flowers cards: teaching cards that facilitate learning the vibrations and frequencies of the depicted flowers. For instance, a first side of the card has written information about the flower, and on the reverse side is the photograph of the flower. The obvious disadvantage of those cards is that the person may be influenced by the photograph and, therefore, complete analysis of the person's cognitive or intuitive selection process is not available.

In still other examples of the use of visual cards for diagnosis, on one side of a card is an element of only two colors that varies from card to card. The other side is identifiable with the rest of the cards (i.e., the same uniform pattern or image on all the cards). The disadvantage of those cards is that two colors alone do not provide sufficient information for analysis and they do not offer treatment solutions. Since one side of the cards is identifiable with the rest of the cards they do not afford the option of analysis and guided choice by the person being assessed.

Still in another example, tarot cards, like those shown in FIG. 3 (in black and white), are well known in the market. They are based on the doctrine of the message of the classic form of the tarot, and can only receive one pair of colors. The cards allow for reception of additional information based on the classic interpretation of the familiar card. Traditionally, so-called “mystics” work with tarot cards and are asked to find an answer about the future disposition of a person based on the cards presented. The disadvantage of tarot cards is that they are not aimed toward any kind of treatment. Therefore, they are not appropriate for treatment providers who are asked to analyze thinking patterns that may be a cause of certain illness.

Although many features of the present holistic method are described in the prior art, none of the prior art methods and cards are directed to a method aimed at diagnosing and subsequently treating a person through a combination of color frequency and Bach Flower cue cards which provide an advantage over previous methods as described hereinafter. There remains, therefore, the need for such a method to provide medical and non-medical healthcare providers and other practitioners with an appropriate assessment and treatment tool.

### SUMMARY OF THE INVENTION

The present invention involves the use of diagnostic cards each containing a front and reverse side. On the front and reverse sides of the cards is a unique combination and arrangement of colors, shapes and information. “Reading” the cards by a tester after they are selected by a person being analyzed is a tool based on different research traditions. Those traditions include the Kabbalah, color theory (the psychology of color and the Yogic view), and the teachings of Dr. Edward Bach with Bach Flower remedies (i.e., a homeopathic analysis).

The cards of the present invention are effective in the fields of psychology and healthcare. The cards can be used to understand the personality of a person and the causes that drive personality. They may be used to assist in the discovery of solutions for difficult behavioral problems. In the field of healthcare, it is possible to use the cards as an analytical tool for focusing on a chosen treatment regime.

It is recognized that the human mind analyzes color and light intensity. Every color vibrates at a certain known frequency and certain frequencies may be associated with different patterns of thinking. For example, it is not uncommon to find different places painted certain colors that are appropriate for the character and the demands of the location: a hospital demands color frequencies appropriate for calmness and healing; a pub or bar requires energetic colors and warm hues; a children's school bus is painted bright yellow to alert others to its presence; and red directional signs and traffic lights are well-understood symbols for danger. Thus, using frequencies of light (i.e., colors) has great value in psychotherapy.

Individuals may be drawn to different color frequencies at different times in their lives. The attraction to a particular color may be a need for that same vibration that may be out of balance. That is, being attracted to that color may be a person's subconscious need for re-balance and wholeness. The present invention is a tool that provides an investigative starting point for the acquisition of information about a person as a first step in treatment. Properly employed, the invention can provide an analysis of a person and thus is a source of information about the person. It can uncover types of personality, attitudes, behavior, ambitions and thought patterns. It can also assist practitioners in assessing information about how a person perceives of himself and deals with himself and others.

Accordingly, it is a principal object of the present invention to provide a series of cards containing colors, patterns and information on both sides.

It is another principal object of the invention to provide a method for using the series of cards by a practitioner for psychological assessment and treatment of a person.

Still another object of the invention is to provide a series of cards in which each card has a unique arrangement of colors, patterns and information so that no card in the series is repeated.

It is still another object of the invention to provide a method in which a series of cards are used to assess a person's personality, attitudes, behaviors, ambitions and thought patterns and then are used to provide treatment for that person by practitioners, including holistic healthcare providers and non-medical healers.

These and other objects and features of the present invention are accomplished by the present invention, as embodied and fully described herein, which includes a series of cards that depict three spheres arranged vertically in a column or horizontally in a row on each card with up to six different colors (up to two colors per sphere). A person chooses four cards from the series that he is particularly attracted to after examining all of the cards. Using his choices, the person's thought process and patterns that may be inhibiting him, aspirations and his personality may be assessed. Based on the selection, an appropriate formulation of Bach Flower essences may be prescribed for individualized treatment.

An advantage of the present cards and method is that the person being assessed chooses the card according to what is visible to him on the cards, i.e. a series of different colors. Each card presents a different series that is matched to the person's thought processes. On the other side of the cards is a result showing patterns of thinking symbolized by homeopathy (flower) and allows treatment to occur with the use of Bach Flower remedies. Thus, each card is not identified with any other card, and each card is unique to that essence of thinking pattern.

With these and other objects, features and advantages of the present invention that may become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a plan view of a front and reverse side of a card that is well known in the prior art;

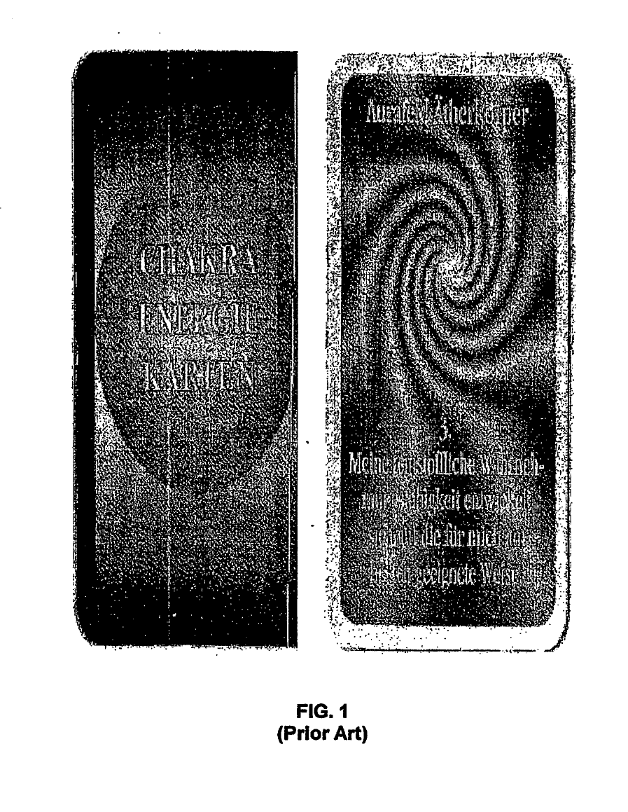

FIG. 2 is a plan view of a front and reverse side of a Bach Flower card;

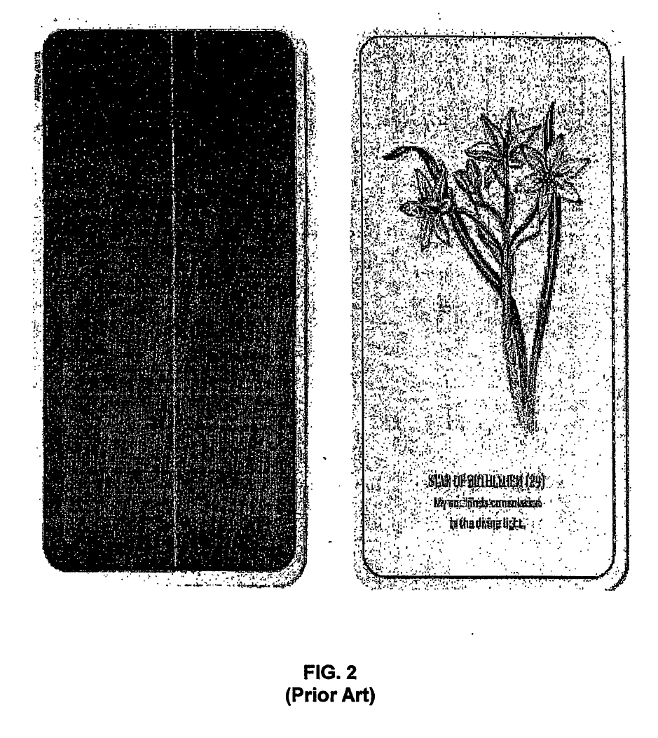

FIG. 3 is a plan view of a front and reverse side of a traditional tarot card;

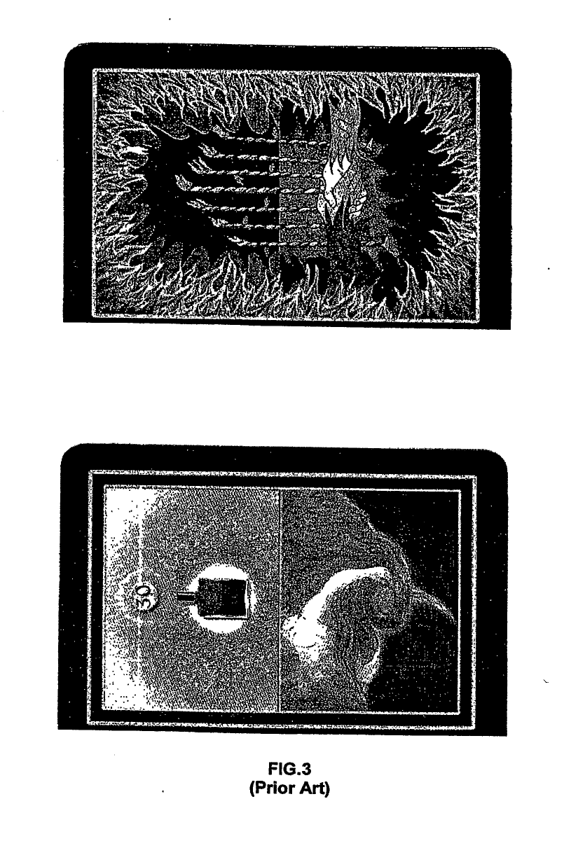

FIG. 4 is a plan view of a front side of a first and second card of the present invention showing three spheres on each card; and

FIG. 5 is a plan view of a reverse side of a first and second card of the present invention.

### DETAILED DESCRIPTION OF THE INVENTION

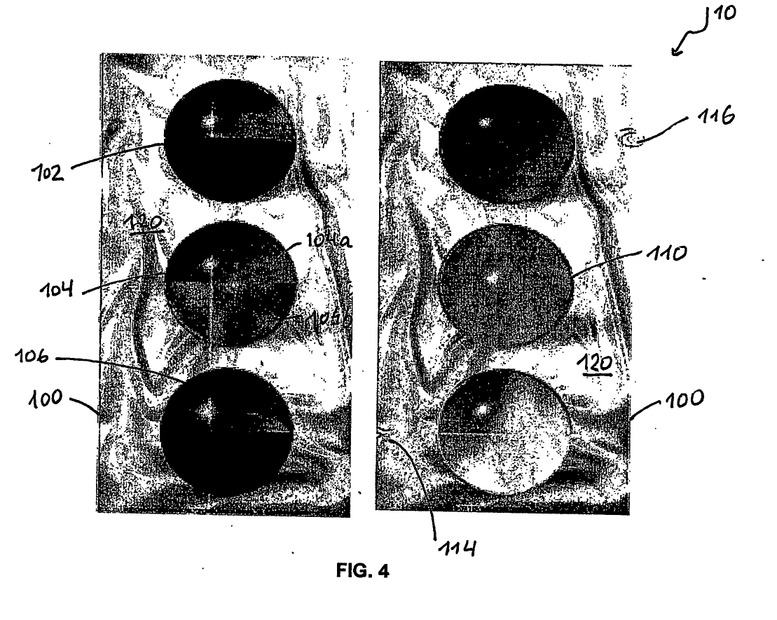

In the present invention, several preferred embodiments are described for illustrative purposes. Referring first to FIG. 4, a plan view of the first sides of two cards (10) of the present invention is shown. The left and right cards (10) may be designated Card 1 and Card 2, respectively. The view shown is the diagnostic sides of the card (100) that facilitate impressionable choice with special emphasis on the choice of three colors. The choice is based on the doctrine of the Kabbalah (the Tree of the Ten Spheres), and on color theory as previously described. Each card (10) of the present invention is different than the other cards in the series. That is, no card (10) of the series is identifiable with another card of the series.

The term “diagnosis” in the context of this invention means also to investigate, deduce, assess, test and evaluate a person for purposes of treatment. The term “diagnosis” is not meant to be limited to its ordinary meaning in the field of medical care, in which “diagnosis” may involve physical testing of a person.

The diagnostic side of the card (100) includes geometric forms of three colored spheres (102 through 106, respectively), some of which are divided into two halves (i.e., 104a and 104b) and some of which are whole (i.e., 110). Additionally, two small symbols (114, 116) are located adjacent to specific spheres and indicate special consideration. The spheres are positioned over a neutral background pattern (120). The three color spheres and small symbols indicate the following: 1) an area of the body, and 2) a difficult emotional state of the person being assessed.

Further, the cards are divided into series: the centers of energy (Chakras), which signify the location and cognitive image parallel to it; and the “Rescue Series,” which deal with difficult emotional situations (according to color and its meaning). There can be any number of cards (10) as long as they are each unique; preferably there are a total of 39 cards.

The use of three spheres (e.g., 102, 104 and 106) of color on the cards (10) is based on several different doctrines of holistic healing. First, the doctrine of the Kabbalah speaks of the “Tree of Life” (the “Tree of Ten Spheres” as a model) that reflects the way of creation that is completely healthy. The whole Tree is divided into thirds. Second, the Yogic viewpoint also speaks of three basic powers that constitute man's energy centers and correspond to the understanding of colors wherein the three basic powers relate to the vibration frequency of red, yellow and blue. Those three colors, in combination with each other, can produce the entire spectrum of visible color frequencies. Third, the basis of matter is the combination of three things: protons, neutron and electrons.

The colors of the spheres may be associated with certain symbolism and a possible psychological imbalances of a person being assessed, as noted on Table 1 below.

TABLE 1

| Color | Symbolism | Imbalance |
|---|---|---|
| White | Opportunity; purity | Obscurity, emptiness, complete |
| | | self-denial; feelings of being |
| | | overwhelmed; perfectionism |
| Red | Action; survival | Material problems and survival |
| | | issues |
| Pink | Love | Difficulties giving/accepting love; |
| | | vulnerability, blocked emotions, |
| | | confusion between softness and |
| | | rigidity, angry dependencies, |
| | | problems with self-acceptance, |
| | | self-directed aggressiveness, |
| | | conditional love, hunger to love |
| | | and be loved, smothering love |
| Coral | femininity; sensitivity; generosity; | Fear of being disappointed; |
| | independence/interdependence | investments of love not answered |
| | | in the past, inability to forge real |
| | | connections after previous |
| | | disappointments |
| Orange | Happiness, initiative, vigor, | A sense of threat from outside |
| | excitement; creativity, vitality, | sources; social problems and |
| | bliss, and cheerfulness | dependencies |
| Gold | Culturally, verbally expressive; | Problems of safety; fear, lack of |
| | wisdom, insight, good intuition, | logic based on poor confidence; |
| | correct use of the repositories of | poor self esteem, deep confusion, |
| | memory | false understandings, loss of |
| | | courage and self protection, |
| | | worsening self judgment, shame a |
| | | need to justify oneself, a need to |
| | | achieve/acquire credentials for the |
| | | purpose of self-worth |
| Yellow | Acquired knowledge, cognitive | Dark fears and phobias caused by |
| | and intellectual understanding, | experiences or memories; need to |
| | planning, instruction/teaching; | control circumstances because of |
| | individual identity, curiosity for | suspicion |
| | information, ability to comprehend, | |
| | strength of will, spiritual focus, | |
| | strength, awareness, optimism, | |
| | artistic and creative talent, | |
| | proneness to ideas and scientific | |
| | inventions | |
| Light Yellow | Higher knowledge; clarification/ | Fears in the spiritual sphere; nerve |
| | illumination | problems in the head area; |
| | | frustration, fear and separation |
| Green | Hope, expansiveness, direction | Loss of connection to inner truth |
| | | causing difficulty in making |
| | | decisions; holding tightly to |
| | | inhibitions; subjectivity |
| Emerald Green | Ability to bring peace to | Lack of clarity of emotions and |
| | surroundings and to release | intercommunications |
| | formerly held opinions | |
| Olive Green | Optimistic and practical person, | Fears of the heart; problems of |
| | integrated and authoritative; | control and power, inflexibility, |
| | leadership, feminine | dissatisfaction, rigidity or |
| | empowerment, cooperation without | frozenness; inability to move |
| | competitiveness; justice; truth; the | things along; evasiveness, fraud, |
| | wisdom to release bitterness, fear | betrayal, camouflage, fear of |
| | and old habits; openness to new | expressing true feelings; feelings |
| | ways; personal flexibility | of unfairness and bitterness |
| Pale Green | Watery; peace of wide open spaces | Inability to focus, difficulty in |
| | | making decisions, searching for |
| | | personal identity; problems with |
| | | connecting to the inner truth, |
| | | abandonment of personal |
| | | responsibility in his own life |
| Turquoise | Group communication; speaking | Difficulties in expressing emotion |
| | out; idealistic and independent, | |
| | loves equality, brotherhood, self- | |
| | confidence, personal responsibility, | |
| | goal oriented and self-actualized; | |
| | abilities in technical | |
| | communication (science) | |
| Light Turquoise | A new message | Creative blockages, cannot find |
| | | connection to inner guide |
| Blue | Observation; connection with the | Problems with reliability, lack of |
| | inner voice; quiet mind; tolerance | protection, holding onto old |
| | towards ourselves; protecting and | opinions and troublesome |
| | calming | thoughts, pressure and lack of |
| | | concentration, over-worry and |
| | | sleep disturbances; hesitations, |
| | | tentativeness, cool emotions, |
| | | impatience, things that cause |
| | | distancing from self and one's |
| | | surroundings |
| Sky Blue | Pure ambition; protection; mature, | Lack of protection, lack of faith, |
| | ripe, strong-willed, peace and | no clear thinking with oneself and |
| | cosmic serenity, communication of | the surroundings. |
| | inner and outer serenity, psychic | |
| | energy, creative and powerful | |
| | expression. | |
| Royal Blue | Devotion and mysticism, | Heavy heart and deep depression, |
| | uncertainty; true heart, loyalty, | troubled dreams; aloneness, |
| | deep connection to one's work, | isolation, wandering, inner |
| | obedience and fulfilling obligations | repression, inner emptiness, |
| | altruistic devotion to social | addiction, lack of sympathy, too |
| | concerns, science or art; tendency | much emotion, and uncertainty |
| | to spirituality, mysticism in its | |
| | deepest image, the third eye, extra | |
| | sensory sight, listening and sensing | |
| | beyond the usual range | |
| Purple | Transformation and ascension | Sadness, pain, anguish, great loss, |
| | | depression, sleep disturbances, |
| | | grief, the feeling of the severance |
| | | from one's true essence, the need |
| | | to escape to another world (to |
| | | blue); use of unnatural incentives, |
| | | like drugs and alcohol; inability to |
| | | apply oneself, obsessive thought, |
| | | sleep disturbances, loss of the |
| | | connection with self and others, |
| | | great debilitating tension, hidden |
| | | anger which can become over- |
| | | controlling |
| Light Purple | Spiritual service; spiritual | Degeneration of the spirit and of |
| | sacredness, purity, cosmic love of | worship; difficulties with the |
| | justice, the justice of inner balance, | physical world |
| | spirituality, spiritual guidance | |
| | (guru), new experiences, healing | |
| | services, meditation and ascension | |
| Magenta | Change, release of habits, works of | Gloominess, unlimited pain, the |
| | compassion; mothering, being in | search for love outside human |
| | the right place at the right time for | experience; smothering love, |
| | ourselves and others; liberating | obsession; suffering in the heart |
| | love and concern | and in the stomach |
| Light Magenta | Concern and compassion by way | More passion than softness; |
| | of telepathy; instinct which is | smothering, obsessive love |
| | finely tuned towards others | |
| | telepathically; liberating love | |
| | combined with non-judgmental | |
| | service | |

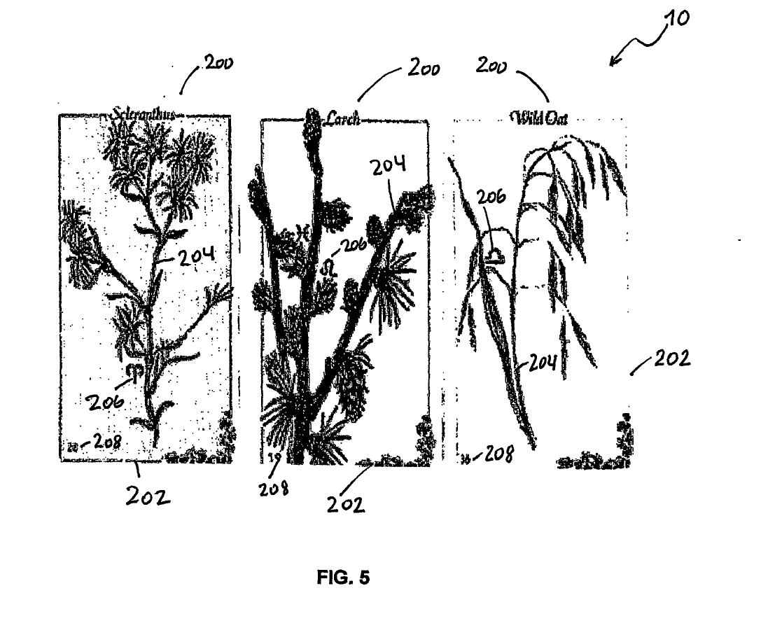

Referring now to FIG. 5, a plan view of the reverse sides of three cards (10) of the present invention is shown. The reverse sides of the cards (200) include a geometric form (202), and within those forms a drawing of a flower (204), one or more astrological symbols (206), and a numerical number (208). The numerical number (208) is selected from the method of numerology. The reverse sides of the cards (200) provide for the treatment aspect of the invention. All of the information on the cards is parallel to the essence and formula of thought patterns, and corresponds to the choice of the trio of spheres on the front sides (100) of the cards (10) (see FIG. 4). This is matched by the theory of homeopathy (i.e., the theory that “like cures like”).

The Bach Flowers on the reverse sides of the cards (200) have the meaning suggested on Table 2.

TABLE 2

| Flower | Interpretation | Message |
|---|---|---|
| Agrimoni | This person essentially has talent | Encouragement of the true ability |
| | from birth to generate harmony - a | to laugh at life, in order to allow |
| | personality full of happiness, will | the examination of personal |
| | never make fun of anyone but only | problems from a more balanced |
| | of himself. Very rarely will he | perspective; that of an optimist |
| | accept help. In times of distress he | and one with a talent for |
| | will choose to be among people, in | generating harmony, instead of |
| | order to forget his problems. His | from a place where harmony |
| | tortured soul will be hidden behind | doesn't really exist. |
| | a facade of “everything is fine.” | |
| | Failings - covering up and | |
| | escaping. | |
| Aspen | Fear is the characteristic emotion of | Strengthening the idea that there |
| | this person, although he senses the | is an all-powerful guardian, and |
| | lack of space for vitality, which | that it is the universal power of |
| | stems from too many red lines | love. “The control of gold.” |
| | (boundaries). By setting too many | |
| | limits in his life, he thinks he can | |
| | prevent meeting the fear. He gives | |
| | too much importance to | |
| | catastrophes, if they are realistic or | |
| | imagined, and none to the joyful | |
| | things in life. In spite of his | |
| | tendency to believe that his fears | |
| | spring from real feelings that | |
| | appear around him, such is not the | |
| | case. In reality he acts as a self- | |
| | fulfilling prophecy and brings | |
| | disasters upon himself that could | |
| | have been avoided. | |
| Beech | This person has strong ideals and a | Signifies the ability to see the |
| | strong will. What has brought him | good, the cup half full in |
| | to this point is severe criticism that | everything. The conscious |
| | was turned on him as a child, which | tolerance and understanding of |
| | caused feelings of inferiority. | another's difficulties. The |
| | Sometimes he acts as God's | vibrations of the flower helps to |
| | representative on Earth, from a | change general criticism turned |
| | place of bitterness and repressed | on others and to find the valuable |
| | emotions. He judges and denigrates | goodness in people. |
| | people, a critical nature, intolerant, | |
| | who is turned outward more that | |
| | inward. He is not able to identify | |
| | with the variety of the human race. | |
| | This man finds himself saying, | |
| | “Why can't they be like me?” | |
| Centaury | This person demonstrates over- | The ability to live the life |
| | sensitivity and exaggeration, with a | according to my own assignments |
| | good heart. This vibration signifies | and not for the needs of others. |
| | difficulty to connect with inner | The vibration aims towards strong |
| | power. Naturally docile and | will and assertiveness. |
| | unconsciously submissive towards | |
| | a strong, authoritative person. Will | |
| | often give up his identity and | |
| | relinquish his own needs, admires | |
| | and serves others whom he feels | |
| | are strong, due to his wish to be | |
| | connected or to be “okay.” The | |
| | child tried very hard; the adult feels | |
| | exploited, even a victim to his life | |
| | in shadow. | |
| Cerato | The person knows what he wants, | The ability to differentiate |
| | but is not confidant that the answer | between good and bad and to |
| | is the right one. Therefore he | have trust in his own inner voice. |
| | always will ask for strength from | The knowledge that what he |
| | his surroundings for every action. | decides is the best decision for |
| | Apparently he is suspicious of | him. |
| | taking responsibility for his | |
| | choices. In his behavior he mimics | |
| | other's styles as a way to | |
| | acceptance, for their permission for | |
| | him to exist. | |
| Cherry Plum | Fear of a loss of control. Feelings | The conscious belief in the power |
| | of personal threat. This person isn't | that is concealed within me is |
| | capable of restraining within | under my control, and is there to |
| | himself what he experiences, and | serve my needs. This power will |
| | reacts like a volcano. However, the | be fuel for every action I choose; |
| | moments when he feels that he will | a letter of compliant, starting a |
| | explode are blocked, preventing | book or the housework. |
| | complete emotional shattering. | |
| | These feelings stem from | |
| | prolonged periods of fear and | |
| | sadness that may lead to emotional | |
| | breakdown. | |
| Chestnut Bud | Cycles in life - deja vu. Problems | This frequency works on the |
| | in learning from mistakes, from | ability to remember unpleasant |
| | lack of focus; inability to be in the | experiences, in favor of a useful |
| | present, missing the capacity to | reservoir of memory and |
| | examine, lethargy, over-hasty | experience. |
| | behavior, inattention, boredom. It | |
| | is possible that this person finds | |
| | himself entering once again into | |
| | unhealthy relationships. | |
| Chicory | This person senses that he is not | To advance self confidence and |
| | getting the affection and love that | the ability to provide care without |
| | he should have, and therefore he | demanding something in return. |
| | becomes manipulative and sly, | |
| | demanding sympathy from others | |
| | and causing guilt feelings. As a | |
| | parent this type is overprotective, | |
| | controlling and rather smothering. | |
| | Finally he feels rejected and | |
| | stepped on, when all he wants is to | |
| | receive recognition and affection. | |
| | Along with this is the feeling of | |
| | emptiness, under-achievement, and | |
| | self-pity and possessiveness. This | |
| | vibration focuses on childhood that | |
| | lacked affection, and at times also | |
| | fear of abandonment. | |
| Clematis | The idealist who is removed from | This frequency allows for the |
| | reality. “Joseph the dreamer.” This | ability to bring into the present |
| | person finds himself disconnected | the creative dreaming and |
| | to what is happening around him, | ambition to be realized. It allows |
| | dreaming and bumping into things | awakening, and to value life's |
| | along with having creative | goals. |
| | ambitions. Awake and dreaming, | |
| | apathetic, thinking of the future, | |
| | hearing without listening, looking | |
| | without seeing, loves to sleep. A | |
| | quiet person with little really | |
| | happening. | |
| Crab Apple | This person needs to feel pure | This vibration opens the potential |
| | (mentally and physically) and | to see things in a correct |
| | satisfied with his looks, coming | perspective, and encourages self- |
| | from a feeling of self-disgust. It is | respect. |
| | connected to types of people that | |
| | are very organized, clean to the | |
| | point of exaggeration. They put | |
| | emphasis on marginal details, | |
| | sometimes feeling that they must | |
| | wash their hands after each action. | |
| | When something is out of order, | |
| | according to his ideal view of the | |
| | way things should be, it creates | |
| | tension; often signifying a narrow | |
| | outlook in other areas. (This makes | |
| | sense, since this vibration touches | |
| | on self-disgust, which can stem | |
| | from a violent or cruel act in the | |
| | past). | |
| Elm | A successful person who fulfills the | This vibration tunes the |
| | goals of his life, but sometimes | knowledge for taking time and |
| | experiences deep depression and | seeking rest for renewal of the |
| | sorrow. He feels that he has taken | soul and of judgment. It puts |
| | on burdens that are too much for | things far enough away to be |
| | him. The sense of failure locks him | objective, and so there is no |
| | in a corner. A person who stops | reason to worry. |
| | his capabilities and temporarily | |
| | loses his confidence. There are | |
| | those who label these weak | |
| | moments of strong people. | |
| Gentin | This person loses his self- | The frequency opens up the belief |
| | confidence often, which brings | in a positive outlook on things. |
| | negative observations, pessimism | The ability to see the glass half |
| | and suspicion. Any delay or small | full, which encourages dealing |
| | trouble brings doubt and a sense of | with things as they are. |
| | failure. Because of this, he gives | |
| | up and from the beginning does not | |
| | invest the necessary effort. | |
| Gorse | This person has a sense of being | Development of the soul to return |
| | unsure, of despair and | to balance; and the understanding |
| | disappointment. A sense of | given in order to overcome any |
| | hopelessness, and of darkness. | problem, and that each problem |
| | This period fits with the feeling that | demands its own time. |
| | comes with the end of a romance or | |
| | a relationship (or a time of illness). | |
| Heather | This person is in need of affection | This vibration encourages |
| | and a sense of value. He tends to | empathy and hearing the other. |
| | cause each conversation to be only | |
| | about him. He has feelings of | |
| | isolation and he gives himself self- | |
| | pity, while all he wants is affection. | |
| | This vibration shows a deprived | |
| | childhood without having gotten | |
| | what he needed. Such things bring | |
| | him to egocentricity, possessiveness | |
| | and the inability to listen to | |
| | the needs of others. This person is | |
| | unable to be alone. | |
| Holly | This vibration signifies a person | Developing the power of love |
| | who is extremely sensitive, who | gives the opportunity to give |
| | protects himself by inflating his | without thinking about being paid |
| | ego, rage, anger, and perhaps even | back, and the ability to rejoice in |
| | the power of his arm. This is | the happiness of others. |
| | caused by a large lack of love. The | |
| | flower's vibration indicates | |
| | suspicion, rage and revenge as a | |
| | power that fuels what can become | |
| | hate and jealousy. The antithesis of | |
| | great power is the power of love. | |
| Honeysuckle | This person lives with nostalgia for | To advance a new way with the |
| | the past, or he doesn't want to | release of the old and freeing up |
| | outwardly age. He has a difficulty | space for the new. To experience |
| | dealing with change. Clearly he | new things, with the maturity to |
| | has experienced failures and lives | understand that the blockage is |
| | within them. This vibration can | from the distant past, when |
| | signify inability to renew | emotional maturity was less. The |
| | connections after separation. | ability to bring the “package” of |
| | | the past to an appropriate place |
| | | today, with the mature |
| | | understanding of today - and with |
| | | it of course, release. |
| Hornbeam | A person who is able to be | This vibration allows a push |
| | persistent, but such persistence is | forward; a renewed interest in |
| | his trouble. Just thinking about a | life. Illuminates interest in |
| | task tires him, which undermines | normal activity and less in self. |
| | ambition. With a lack of | |
| | excitement, especially tired of the | |
| | normal routine, his soul is | |
| | exhausted and without stimulation | |
| | and daily challenge. This is a sign | |
| | of difficulty in decision-making, | |
| | for instance starting the weekly | |
| | routine or having difficulty in | |
| | waking up in the morning. | |
| Impatiens | A person who is quick of thought | Encouragement of empathy, |
| | and action and wants deeds to be | patience and tolerance, which |
| | done with no hesitation or delay, | allows for understanding of |
| | and wants immediate results. | others' shortcomings. |
| | There is a situation of pressure and | |
| | tension, a “short fuse.” Tries to | |
| | make other people hurry up. He is | |
| | a leader although he doesn't want | |
| | to be, and prefers to work alone at | |
| | his own pace. Even so, he senses | |
| | isolation which comes from his | |
| | sending messages of impatience | |
| | and short temper. | |
| Larch | This person does not consider | Development of self-confidence |
| | himself capable enough in | and perseverance even when there |
| | comparison to those around him. | is failure. This vibration brings |
| | He delays his reactions and easily | forward wisdom to know that |
| | submits. Suffers from lack of | each person is special. |
| | confidence and expects failure. As | |
| | a consequence he doesn't dare to | |
| | act and misses many opportunities | |
| | in life. Doubtful and wary about | |
| | himself, introverted, shy and not | |
| | very social. | |
| Mimulus | A quiet person that bears hidden | This vibration advances courage |
| | fear. Probably shy and blushing. | to deal with difficulties and to |
| | There is fear within him, defined | overcome reservations. |
| | and well known, for example: fear | Understanding that anywhere |
| | of flying or of the dark, pain, | where there is an enemy of love, |
| | accidents, or fear of specific | there is no room for fear. |
| | animals. This is connected to a | |
| | tragedy in the past. | |
| Mustard | This person experiences feelings of | Helps understanding that the |
| | gloom and waves of despair for | situation is temporary, the sun |
| | which there is no discernable | will soon return to illuminate, the |
| | reason. Like a cloud that hides the | cloud will disappear and thoughts |
| | light in life, and like a cloud these | will clear. |
| | feelings disappear as quickly as | |
| | they appear. This vibration is | |
| | especially helpful for hormonal | |
| | fluctuations. | |
| Oak | This person is not a short-term | Advances the understanding that |
| | friend. He will never lose hope and | the breaking point will come from |
| | will always help. But within | too much weight. It also opens the |
| | himself he fights a battle for | possibility to divide the burden |
| | survival. He's stubborn in his | with others. Hard work and |
| | uncompromising effort against all | achievement are not the only |
| | odds. This frequency shows a | goals. Life is made up also of |
| | strong person physically, maybe | lightheadedness and delicate |
| | even broad shouldered. Others pile | tears. |
| | upon him additional responsibility, | |
| | which could cause him emotional | |
| | collapse from overwhelming | |
| | pressure. | |
| Olive | This person senses that he is at the | Encourages understanding of the |
| | end of his energy, as if a great | need for release from the race of |
| | effort has been going on since | life, to take time to rest in order to |
| | childhood. There is mental and | recharge new energies, time to |
| | physical exhaustion. It's possible | gather strength and return to |
| | that there has been remarkable | vitality. |
| | physical or emotional suffering, | |
| | and a sense that there is no longer | |
| | any strength for more effort. | |
| | Drained of all energy. Fitting for a | |
| | time of overwork or over-worry of | |
| | the mind and the body. Severe | |
| | exhaustion and weakness. | |
| Pine | This person tends to blame and | Encourages acceptance and |
| | condemn himself. These guilt | compassion for the self. |
| | feelings bring despair and | Responsibility should come from |
| | unhappiness. He holds onto | a fair and appropriate attitude. |
| | exaggerated doubts and has a | |
| | tendency to be exploited often. He | |
| | criticizes himself even in times of | |
| | success, that he really could do | |
| | better. It indicates someone who | |
| | can also take the blame of others | |
| | upon himself. | |
| Red Chestnut | This person experiences feelings of | Development of secure, safe |
| | threat and fear for the existence of | thoughts and courage. The |
| | others. There is over-concern for | knowledge to broadcast goodness |
| | those close to him, (family, friends, | so that's what will be received. |
| | children, etc.). Negative thoughts | The understanding that prophesies |
| | hurt not only him but also others | fulfill themselves. |
| | upon whom his negative thoughts | |
| | are reflected. This person | |
| | sometimes looks ahead to a | |
| | troublesome thing and without | |
| | meaning to, causes it to happen. | |
| Rock Rose | At one end, the embodiment of fear | This frequency encourages |
| | itself, and at the other end, a person | bravery, and the will to take risks |
| | who is willing to risk their life to | for the sake of others. |
| | help others. The fear comes as a | |
| | result of things that were seen or | |
| | experienced in life, situations of | |
| | terrible fear and horror. This | |
| | vibration can signify panic attacks | |
| | from tension or suspense, and even | |
| | nightmares. | |
| Rock Water | This person has too much self- | Encouragement and advancement |
| | discipline, rigidity, repression and | of open thoughts. Variety in life is |
| | self-denial. He is precise and strict, | an expression of pleasure and |
| | without compromise or flexibility, | enjoyment, and so can make |
| | which causes blockages. He has | inspiration possible for |
| | high ideals, a perfectionist that | everything. |
| | prevents himself from enjoyment | |
| | and gladness. Gives too much | |
| | attention to small details and can | |
| | miss the big picture. This person is | |
| | controlled by his thoughts and his | |
| | whole life revolves around making | |
| | things happen by force, perfection | |
| | and rigidity. Instead of concentrating | |
| | on life, he concentrates on a | |
| | goal for which he tortures himself. | |
| Scleranthus | This frequency is identified with | Correct consideration from a |
| | problems in reaching decisions that | place of balance and acceptance. |
| | must be made between two things: | This vibration advances the |
| | “heads or tails.” Mental unquiet, a | identification of unnecessary |
| | quiet person who goes through | inner dilemmas and allows for |
| | difficulties alone and doesn't allow | their release. |
| | for discussion on problems with | |
| | others; introspective. He may | |
| | sense mood swings, much polarity | |
| | and changing symptoms. | |
| Star of Bethlehem | It's probable that this person is in a | The understanding that energy, |
| | difficult position, feeling distress | when it is trapped in the body, |
| | from despair and suffering from a | demands to be released. Such |
| | fateful event in his past. A shock | energy attracts similar situations, |
| | caused by terrible news, or loss; | causing repetition of the negative |
| | spiritual or physical trauma; all of | energy in life. This understanding |
| | these have the same effect. A | neutralizes the shock effect |
| | trauma from the past that is still | immediately. |
| | real and causes inhibitions, | |
| | blockages and uncontrollable fears, | |
| | which prevent progress on the | |
| | emotional, cognitive, mental and | |
| | physical levels. Can cause | |
| | headaches, depression, anxiety and | |
| | anger. | |
| Sweet Chestnut | This person is stuck deep within | Focus the strength and |
| | himself and needs fantastic spiritual | understanding, because for |
| | strength to extricate himself. His | everyone, personal experiences |
| | life has shattered into a million | on the meaning of life bring about |
| | pieces. Everything that he sees | a scattering of sadness, and a |
| | indicates evil. Feelings of wanting | return of hope in a new light. |
| | to burst into tears dissolve into the | |
| | deep despair. It reminds one of | |
| | difficult periods for children whose | |
| | parents have divorced. Such | |
| | feelings bring thoughts that smiling | |
| | is worthless. | |
| Vervain | This frequency symbolizes the need | This frequency symbolizes the |
| | to change the current situation. This | ability to keep calm, open |
| | person has strong will and courage; | thinking, and the recognition that |
| | he tends towards hyperactivity. The | others have the right to have their |
| | challenge of changing something | own opinions. |
| | causes frustration and stress. It's | |
| | hard for him to suffer injustice, and | |
| | he always uses the pretext that it is | |
| | his concern for others that | |
| | motivates him. It is nice to see | |
| | how completely convinced he is of | |
| | his justification, even to the point | |
| | of his becoming coercive. He finds | |
| | himself involved in projects | |
| | concerned with justice and the | |
| | welfare of others. | |
| Vine | Leaders, rulers, lords, for better or | This vibration is a sign of |
| | worse. This person wastes his time | compassionate leadership, which |
| | on the need to establish his status | creates devoted followers. The |
| | (he tends to take advantage of his | knowledge to use power as a tool |
| | powers to control other people). He | for lifting up rather than as a |
| | can become a cruel merciless | weapon. |
| | dictator, to those around him. He | |
| | expects his orders to be carried out | |
| | immediately, and demands | |
| | complete obedience. Arguments | |
| | with him are not always civilized or | |
| | pleasant. He will not be found in | |
| | situations where he has inferior | |
| | status. | |
| Walnut | This person feels unprotected and | This frequency is a sign of inner |
| | exposed. This frequency | protection, aimed at the |
| | symbolizes times of too much | knowledge to release oneself |
| | emotion, sensitivity to ideas or | from emotional involvement. |
| | outside influences, a time where he | Sharpening the skill of being an |
| | is very influenced by others and | observer, to understand what |
| | feels vulnerable as a result of being | drives others, the knowledge to |
| | emotionally involved in events. It | weigh correctly and to decide |
| | is a time of temptation to stray | about the truth for oneself, which |
| | from the path towards a goal, after | may not be the truth for others. |
| | being convinced by the strong | |
| | opinions of others. It hints at being | |
| | a time of change. This frequency | |
| | is appropriate for menopause and | |
| | for times of growth and change, | |
| | such as changing homes or | |
| | professions; the process to a new | |
| | path. | |
| Water Violet | This person keeps pain and | This frequency advances the |
| | suffering deep in his belly; it can be | ability to call up wisdom and |
| | said that this is the vibration of a | sympathy, in order to make his |
| | man of honor. He listens to what is | talents available to serve society. |
| | said, but avoids taking advice, in | Advances openness and getting |
| | order to prevent invasions of his | pleasure form society. |
| | privacy. Patronizing, has strong, | |
| | impenetrable armor that builds a | |
| | wall of isolation from society, but | |
| | out of choice. He may be seen as | |
| | snobbish, cold, arrogant and | |
| | boastful, prideful and distant. The | |
| | difficulty arises when he feels | |
| | lonely, needs company and some | |
| | feedback from society. | |
| Water Chestnut | Suffering from a “chattering” brain, | Development in knowledge for |
| | which prevents clarity and | finding serenity and a balanced |
| | illuminated thinking. This | space for thoughts. The ability to |
| | frequency symbolizes bothersome | control thoughts and knowledge |
| | thinking. Inner arguments, ideas | and to use them constructively for |
| | and concerns that go around in | solving problems. The wish to be |
| | circles and never get anywhere, “the | the boss, instead of the slave, to |
| | thought carousel”, which can | your thoughts. |
| | cause sleep disturbances and | |
| | difficulties concentrating. (It's | |
| | possible that there is decrease in the | |
| | level of zinc in the body or an | |
| | increase in copper, it's worth | |
| | investigating). | |
| Wild Oat | This person is talented and | This vibration enables the |
| | especially looks for satisfaction and | realization of the path made |
| | fulfillment. With so many talents, | possible by directing his talents in |
| | he finds himself on a constant | the pursuit of one goal and the |
| | search for the right way to get to | chance for finding inner |
| | his goals. It's very possible that | satisfaction by observing what |
| | also because so many things are at | catches his interest or attracts |
| | his disposal, he becomes confused, | him. |
| | becoming less able to make | |
| | decisions. This person quickly | |
| | discovers that he becomes bored | |
| | and frustrated (not always finishing | |
| | what he started) which causes him | |
| | trouble with consistency and causes | |
| | him to spread his energy around in | |
| | many directions. He feels like a | |
| | lost soul that has not yet found his | |
| | place in life. | |
| Wild Rose | Apathetic and submissive. This | A frequency that encourages the |
| | person accepts the routine of his | will for change, to create new |
| | life as if it was preordained fate. | things, encourages pleasure from |
| | Worrier, gloomy, uncomplaining, | companions, from enrichment. |
| | hates change and accepts suffering. | Brings the wisdom to create an |
| | His life passes without pleasure or | interesting, rewarding life. |
| | enjoyment. “Surfing through life”. | |
| Willow | This person is trapped in feeling | The vibration encourages the |
| | like a victim, in unhappiness and | understanding that in each event |
| | despair. Like bad luck, such | in life there is some personal |
| | resentment can bring him to hold | responsibility. Advances |
| | grudges. This distress is turned | responsibility, the discovery of |
| | inwards and eats at his heart, and | optimism, and a sense of humor. |
| | he blames his surroundings. Given | |
| | to self-pity, (what we all do, if we | |
| | are honest). Sometimes becomes | |
| | jealous of the happiness of others. | |
| | This vibration shows distress and | |
| | suffering form the past and | |
| | inability to take any more. As it is | |
| | said: “it's not fair”. He has trouble | |
| | shaking the negative outlook on life | |
| | and cannot stop looking for | |
| | mistakes made by others. It is very | |
| | characteristic of them to give help | |
| | to people: family friends, etc. | |
| Rescue Remedy | This is a situation that demands | The knowledge to find the soul's |
| | special consideration; go right | balance, and the wisdom to bring |
| | away to a qualified care provider so | insight for the purpose of |
| | he can match you up with | balancing body and soul. |
| | vibrational essences. This | |
| | frequency symbolizes severe | |
| | distress such as panic, hysteria, | |
| | emotional/mental/physical/spiritual | |
| | shock, the need to escape and | |
| | disappear, caused by traumas, grief, | |
| | etc. | |

It will be understood by those of ordinary skill in the art that the invention is not limited to the colors and plants listed in Tables 1 and 2, and that other combinations of colored shapes and flowering plants may be used without departing from the nature and scope of the invention.

The method of using the cards (10) is now described. First, the person being assessed selects four cards from the series of cards (10). In numerology, the number 4 symbolizes the home. In psychological terms the number 4 represents the place where man resides. According to ideas from the ancient era and the Middle Ages, everything is made from a combination of different amounts of four basic elements (i.e., air, water, earth and fire); there are four levels of the person (i.e., the physical body, the astral body, the soul and the spirit); and there are four basic functions (i.e., senses, emotion, thought, and intuition).

First, the series of cards (10) are spread out with the colorful front side (100) showing. The person being assessed is allowed to look at the colors at his leisure, with no time constraints. Then, the tester or practitioner asks the person being assessed to choose four cards from within the spectrum of colors that are the most beautiful or appealing in his eyes. The person is then asked to choose the most beautiful or appealing sphere (e.g., 102, 104 or 106) from among the three on the front of the card (100). For purposes of this description, the selected card is designated Card 1. The tester or practitioner then arranges the selected cards according to their order of preference from left to right. That is, the one that is selected as the most beautiful or appealing is placed on the left (i.e., Card 1), the one that is next selected from the remaining three as most beautiful or appealing is placed to the right of the first card (i.e., Card 2), and so on.

The four cards selected by the person are symbols of the following: Card 1 symbolizes the spirit (“the halo”) that allows analysis of the basic thoughts of the personality of the person being examined (i.e., originality); Card 2 symbolizes the difficulties and failures that the soul is asking to experience in order to grow, which can pinpoint a sensitive area in a person's physical body; Card 3 symbolizes the soul which is acting in the here and now (i.e., creativity); and Card 4 symbolizes aspirations (i.e., the astral body, or the future) by way of which the person draws energy that forms the present. Those specific orders of the cards and their meaning or explanations may be found in, and are familiar within, the methods of graphology and interpretation of drawings. In those methods, the location of elements of a drawing are important factors.

There are other methods in which four cards may be chosen from the larger series of cards. For instance, tarot cards and other cards may be selected in a different way. However, the explanations for the four cards selected by the method of the present invention are different from those other card selection methods, and are used for the purposes of analysis. As shown in Table 3, there are four views associated with each of the four cards selected by the person being assessed.

TABLE 3

| View | Description | Imbalance |
|---|---|---|
| Spiritual View | Connects us to the Universal | Imbalance will show a person is |
| | source (connection with all living | cut off from seeing any |
| | things), and serves as the basis for | significance and purpose in his |
| | development of the other | life. |
| | viewpoints. (For instance, the | |
| | color blue here would speak of | |
| | communication from a place of | |
| | spiritual thought like channeling). | |
| Cognitive View | The intellect is complicated: made | Imbalance will indicate that the |
| | up of our thoughts, our beliefs, our | old beliefs and values which we |
| | status and our values. Allows for | depend on are not serving us well |
| | the collection of information and | anymore. (For example, the color |
| | wisdom from life experiences. | blue used here indicates the |
| | | mental will to connect to |
| | | authority and guidance. |
| Emotional View | Here is our ability to experience | Imbalance will indicate the need |
| | life at its deepest, and allows us to | to overcome bouts of alcoholism, |
| | find satisfaction in our | drug addiction, serious depression |
| | relationships with the other or | and violence. |
| | with ourselves. (For example, the | |
| | color blue will speak to the | |
| | communication of serenity, | |
| | reconciliation and the capability to | |
| | accept.) | |
| Substantive View | Provides us with the capability to | Imbalance will show damaging |
| | survive and succeed in the | pollution to natural resources, the |
| | material world. | eating of foods that damage |
| | | specific organs. (For example, the |
| | | color blue here can symbolize the |
| | | organ to which it is attracted in the |
| | | body, which in this case is the |
| | | thyroid gland) |

Once the four cards are selected, a broader analysis of the colors presented can be performed. Card 1 will symbolize the basic essence of the one being analyzed. It can represent true desire and the quality of the way in which the soul sees itself and of the way it came into the world, and the wonderful potential that exists within the person and his goals. (In the following choices, this card will represent additional faces of the personality of the individual, and additional essences derived from previous incarnations or past experiences.) The bottom half represents the essence. The top half represents the way in which that essence chooses to come forward and express itself in this life. Together the two colors will give us a life lesson, a messenger and his task. (This card opens up possibilities to understand actions taken to correct matters from previous incarnations.)

Card 2 will symbolize conflicts and difficulties and the place where release is needed. In With this card, we can speak about the colors in relation to imbalance (which can be also be expressed on the physical plane). The gift of this card is the combination of the upper and lower colors to symbolize the additional issues that are waiting to be released as a reward for the ability of the person to break through his obstacles.

Card 3 will symbolize how the person has chosen to behave in the present. The upper part represents the consciousness; the lower represents the energies that are found “below ground” which are preventing him from moving forward. It represents where the person is mentally, cognitively, and spiritually. It shows the basis for future events. With his assistance, the person can navigate himself forward and take advantage of opportunities rather than avoiding them.

Card 4 will symbolize and show what the person will attract toward him in the future, where his soul is heading toward, or what the future may hold should he realize the issues in Card 3. Card 4 also represents the place to which the soul aspires as a result of life experiences. Card 4 represents an important stage for reaching completion among those life experiences.

The reverse side (200) of the card (10) contains the Bach Flowers essences. By the first choice of colors on the four cards, the person being tested has already chosen the four essences that are appropriate for him specifically, and in a very exact manner. From the four essences, one can prepare a personalized essence for support and balancing of the body and soul; to free consciousness, to actualize growth, and to achieve satisfaction. In the final step, the tester or practitioner uses the “message of the flower” to pull out the second card, which holds all of the appropriate information for treatment and inspiration. Treatment, in this case, involves application of the Bach Flower Therapy, which is known in the art. Preparation of essences for the purposes of treatment include the four plant essences that are chosen in order to support and assist the process of personal growth. For purposes of this invention, the term “treatment” means implementation of a regime for instigating psychological change in the person being assessed by the method of the present invention.

Table 4 provides an example in graphical form of the method of using the cards (10) of the present invention. In Table 4, the four cards selected are shown in left to right arrangement as selected by the person being assessed.

TABLE 4

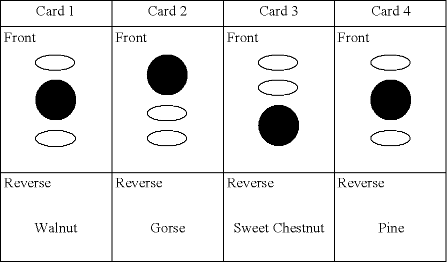

Card 1 was selected based on the middle sphere (104) shown on the front side (100) of the card (10) (see FIG. 4). In this example, the sphere is purple on the top half and fades into blue on the bottom half. This card speaks about the qualities that arrived with the person into the world and about the way in which the soul is represented. As described in Table 1, the person has an artist's soul which has arrived to the world with the ability to communicate by spiritual service and also the service of granting release. He is a quiet person with “mystic abilities.” A soul which arrived with an aim to bring to the world spiritual gifts. It is thought that he can be used as a medium and has the capability to transmit messages to another. This soul chooses to represent itself in the world by way of giving himself to even-handed justice and judgment on every level. The essence of this soul is the search for the spirit in the material plane. He is characterized by deep honesty and spiritual serenity.

The walnut is recommended on the reverse side (200) of Card 1, which symbolizes protection, changes and transformations, and a high level of vulnerability. This essence will grant the person support. The emotional combination causes the person to feel unprotected and exposed, which can trouble his soul's serenity.

Card 2 was selected based on the top sphere (108) shown on the front side (100) of the card (10) (see FIG. 4). In this example, the sphere (108) is turquoise on the top half and fades into light magenta on the bottom half. This card speaks about conflict, difficulty and the place where release and balance are needed. As described in Table 1, this person has experienced unlimited pain, which brings him to a search for love that is outside the human condition—something that does not exist. This is his way of acting out his true essence, a search for the spirit within the material. He has a tendency for obsession. He has difficulty expressing his emotions, can use his potential by communicating for negative purposes, may repress emotions and prefers a mechanical environment rather than a human one. Sometimes he loses the connection with his inner voice, or simply doesn't trust it. Fear of pain causes a person to deny his capabilities, and to become estranged from the environment and the society. His creativity is destroyed, and also gone is the ability to give and receive as an expression of emotional communication. From this person, one can conclude that coupled relationships that are based on give and take communication will be full of difficulties.

The gift from this combination is—a kind of light purple symbolizing deep energy of love, release from pains of the heart, and the ability for sensitive and true communication. This gift will be discovered by the person with his ascension to a higher level of awareness from which he can view his problems and solve them.

The plant gorse is recommended on the reverse side (200) of Card 2, which represents the hope and the wish to return to balance. The flower's message is to become familiar with the person's inner voice and to have faith in it.

Card 3 was selected based on the bottom sphere shown on the front side (100) of the card (10). In this example, the sphere is light purple on the top half and fades into sky blue on the bottom half. This card looks at the present, the here and now in the life of the person being assessed, and at how the soul tries to suggest ways to overcome difficulties. Found in this card is the foundation of the future to come. As described in Table 1, this person is discovered to be brave, courageously dealing with difficulties, and continuing with his search for the spiritual within the material. The person is mature and “ripened” with a powerful will to achieve his goal. He is honest and clear thinking with himself and the society. He is in a situation whereby he has the ability to express who he really is even through silence. These frequencies form the way to actualizing the potential that will appear in Card 4.

The plant sweet chestnut is recommended on the reverse side (200) of Card 3, which is associated with collecting all of the broken fragments, dissipating sadness, and allowing for hope. It expands the light at the end of the tunnel.

Card 4 was selected based on the middle sphere shown on the front side (100) of the card (10). In this example, the sphere is yellow on the top and fades into pink on the bottom.

With Card 4, we analyze the future to come. As described in Table 1, wisdom and knowledge about love, giving and receiving all connected to the color pink, which is the color of universal love, liberating love, self-acceptance, awareness and self-identity. The color yellow represents intellect and learning ability. The combination of the two colors represents the knowledge that is expressed in the belief in unconditional love. The best loved goal of divine thought. Hidden in the future are the energies for the wisdom and the ability to love. Wise love which brings great gifts. The combination of all of the colors produces the color coral, which as noted in Table 1 is a sign of love, femininity, women's intuition, self respect, capacity for love without self effacement, the ability to give to oneself and to others, release from old images and inhibitions which came from feelings of pain and sorrow.

The plant pine is recommended on the reverse side (200) of Card 4, which is associated with uncovering the feelings of guilt in the person. This essence lets a person accept himself, to let go of those feelings of guilt and move towards a rebirth. Shown here is the stage in which the soul grows, a stage in which the soul can leave the past and stop hurting from it. Forgiveness comes from a place of balance, the past is the past which brought experience, and can assist us in not repeating the same mistakes.

Although only a preferred embodiment is specifically illustrated and described herein, it will be appreciated that may modifications and variations of the present invention are possible in light of the above teachings and within the purview of the appended claims without departing from the spirit and intended scope of the invention.

1. An apparatus for individual psychological diagnosis and treatment comprising a plurality of cards of substantially uniform dimension and cross section having a first and second side, wherein the first side comprises one or more of a color, shape and information used in diagnosing a person, wherein the second side comprises one or more of a color, shape and information used in treating the person, and wherein diagnosis is based on the person's selection of at least one card after viewing the first sides of the plurality of cards.

2. The apparatus of claim 1, wherein each card includes two spaced apart and substantially parallel long edges, a top edge spaced apart from a bottom edge, wherein the length of the top and bottom edges are less than the length of the long edges, thereby forming a trapezoid card that is substantially rectangular in shape.

3. The apparatus of claim 1, wherein the plurality of cards form a series comprising a fixed number of cards, wherein each card of the series has a unique first side.

4. The apparatus of claim 3, wherein the fixed number of cards in the series is 39.

5. The apparatus of claim 1, wherein the shape on the first side of the card comprises an image of a sphere.

6. The apparatus of claim 1, wherein the shape on the first side of the card comprises an image of three spaced spheres of substantially uniform size linearly arranged along a common axis parallel to an edge of the card and wherein the three spheres are colored with at least one color.

7. The apparatus of claim 6, wherein the upper half of one or more of the three spheres is a different color than the lower half.

8. The apparatus of claims 1 or 6, wherein the color is selected from the group consisting of white, red, pink, coral, orange, gold, yellow, green, emerald green, olive green, pale green, turquoise, light turquoise, blue, sky blue, royal blue, purple, light purple, magenta, and light magenta.

9. The apparatus of claim 1, wherein the shape depicted on the second side of the card is selected from the group of plants consisting of agrimoni, aspen, beech, centaury, cerato, cherry plum, chestnut bud, chicory, clematis, crab apple, elm, gentin, gorse, heather, holly, honeysuckle, hornbeam, impatiens, larch, mimulus, mustard, oak, olive, pine, red chestnut, rock rose, rock water, scleranthus, star, of bethlehem, sweet chestnut, vervain, vine, walnut, water violet, water chestnut, wild oat, wild rose, and willow.

10. A method for individual psychological diagnosis and treatment comprising the steps of:
displaying to a person the first sides of a plurality of cards having substantially uniform dimension and cross section;
reviewing the cards selected by the person based on the person's review of the first sides of the plurality of cards;
diagnosing the person's psychological condition based on the cards selected by the person; and
providing a treatment regime to the person based on the second sides of the plurality of cards selected by the person.

11. The method of claim 10, wherein the plurality of cards form a series of 39 cards and wherein each of the 39 cards of the series has a unique first side.

12. The method of claim 10, wherein the first sides of the plurality of cards comprise an image of three spaced spheres of substantially uniform size linearly arranged along a common axis parallel to an edge of the card and wherein the three spheres are colored with at least one color.

13. The method of claim 12, wherein the upper half of one or more of the three spheres is a different color than the lower half.

14. The method of claim 13, wherein the color is selected from the group consisting of white, red, pink, coral, orange, gold, yellow, green, emerald green, olive green, pale green, turquoise, light turquoise, blue, sky blue, royal blue, purple, light purple, magenta, and light magenta.

15. The method of claim 10, wherein the second sides of the plurality of cards comprise an image selected from the group of plants consisting of agrimoni, aspen, beech, centaury, cerato, cherry plum, chestnut bud, chicory, clematis, crab apple, elm, gentin, gorse, heather, holly, honeysuckle, hornbeam, impatiens, larch, mimulus, mustard, oak, olive, pine, red chestnut, rock rose, rock water, scleranthus, star of bethlehem, sweet chestnut, vervain, vine, walnut, water violet, water chestnut, wild oat, wild rose, and willow.

16. The method of claim 10, wherein the number of cards selected by the person from the plurality of cards is four.

17. The method of claim 10, further comprising the step of arranging the cards selected by the person in ranked order based on their visual appeal to the person.

18. The method of claim 10, wherein the treatment regime is based on Bach Flowers cards.
